(19) United States
(12) Patent Application Publication
(10) Pub. No.: US 2009/0250974 A1
(43) Pub. Date: Oct. 8, 2009

(54) MOTOR VEHICLE WINDOW ASSEMBLY

(76) Inventors: CHRISTOPHER M. ALBERT, South Bend, IN (US); LEROY C. SCHMUCK, Kendallville, IN (US); ERIC V. WONG, Elkhart, IN (US)

Correspondence Address: BANNER & WITCOFF, LTD., 28 STATE STREET, 28th FLOOR, BOSTON, MA, 02109-9601, US

(21) Appl. No.: 12/061,186

(22) Filed: Apr. 2, 2008

(51) Int. Cl. B60J 1/00

(52) U.S. Cl. 296/201

(57) ABSTRACT

A window assembly includes a frame and a pane having a first portion fixed within the frame and a second portion. The second portion is movable relative to the first portion and the frame from a closed position to an open position. A seal is positioned between the frame and the pane. An operator is secured to the frame and the second portion, and moves the second portion between the closed and open positions.

### FIELD OF THE INVENTION

This invention relates generally to a motor vehicle window assembly and, in particular, to a window assembly with a flexible pane.

### BACKGROUND OF THE INVENTION

Motor vehicles often have one or more venting windows, that is, windows that move from a closed position to a partially open position, and which may be either manually operated or operated by an electric motor. Such window assemblies are used, for example, as venting windows for pickup truck caps to help ventilate the storage area in the rear of the pickup truck, or as a side rear window in a minivan or sport utility vehicle (SUV). Typically such venting windows have a hinge at one end and an operator at the opposed end. The operator is used to push the window to its partially open position and then pull it back to its closed position.

It would be desirable to provide a venting window suitable for use in a motor vehicle that reduces or overcomes some or all of the difficulties inherent in prior known devices. Particular objects and advantages will be apparent to those skilled in the art, that is, those who are knowledgeable or experienced in this field of technology, in view of the following disclosure of the invention and detailed description of certain embodiments.

### SUMMARY

The principles of the invention may be used to advantage to provide a window assembly for use in a motor vehicle. In accordance with a first aspect, a motor vehicle window assembly includes a frame and a pane having a first portion fixed within the frame and a second portion. The second portion is movable relative to the first portion and the frame from a closed position to an open position. A seal is positioned between the frame and the pane. An operator is secured to the frame and the second portion, and moves the second portion between the closed and open positions.

In accordance with another aspect, a motor vehicle window assembly includes a frame and a pane having a first side edge, a second side edge opposite the first side edge, a third side edge extending between the first and second side edges, and a fourth side edge extending between the first and second side edges and opposite the third side edge. The first side edge and a portion of each of the third and fourth side edges are fixed within the frame. The second side edge and a portion of each of the third and fourth side edges are movable outwardly from the frame. A seal is positioned between the frame and the pane. An operator is connected to the frame and the second portion, and moves the second portion between the closed and open positions.

In accordance with a further aspect, a motor vehicle window assembly includes a frame and a pane having a first side edge, a second side edge opposite the first side edge, a third side edge extending between the first and second side edges, and a fourth side edge extending between the first and second side edges and opposite the third side edge. The pane has a first cross-dimension between the third and fourth side edges proximate the first side edge and a second cross-dimension between the third and fourth side edges proximate the second side edge. The first cross-dimension is larger than the second cross-dimension, with a first portion of the pane having the first cross-dimension being fixed within the frame, and a second portion of the pane having the second cross-dimension being movable outwardly from the frame. A seal is positioned between the frame and the pane. An operator is connected to the frame and the second portion, and moves the second portion between the closed and open positions.

Substantial advantage is achieved by providing a window assembly suitable for use as a venting window in a motor vehicle. In particular, such a venting window has a reduced number of parts, thereby simplifying installation, reducing inventory carrying costs and overall costs.

These and additional features and advantages disclosed here will be further understood from the following detailed disclosure of certain embodiments.

### BRIEF DESCRIPTION OF THE DRAWINGS

FIG. 1 is an elevation view of a venting window assembly.

FIG. 2 is a section view of the window assembly of FIG. 1, taken along line 2-2 of FIG. 1, showing a portion of the pane of the window assembly fixed within the frame.

FIG. 3 is a section view of the window assembly of FIG. 1, taken along line 3-3 of FIG. 1, showing the portion of the pane of the window that is free to move with respect to the frame.

FIG. 4 is a section view of the window assembly of FIG. 1, taken along line 4-4 of FIG. 1, showing the operator of the window assembly.

The figures referred to above are not drawn necessarily to scale, should be understood to provide a representation of particular embodiments of the invention, and are merely conceptual in nature and illustrative of the principles involved. Some features of the window assembly depicted in the drawings have been enlarged or distorted relative to others to facilitate explanation and understanding. The same reference numbers are used in the drawings for similar or identical components and features shown in various alternative embodiments. Window assemblies as disclosed herein would have configurations and components determined, in part, by the intended application and environment in which they are used.

### DETAILED DESCRIPTION OF CERTAIN PREFERRED EMBODIMENTS

It will be apparent to those skilled in the art, that is, to those who have knowledge or experience in this area of technology, that many uses and design variations are possible for the window assembly disclosed here. The following detailed discussion of various alternative and preferred features and embodiments will illustrate the general principles of the invention with reference to a window assembly for use as a venting window. Such a vending window may be found in the cap of a pickup truck or as a rear side window in a minivan or SUV. Other embodiments suitable for other applications will be apparent to those skilled in the art, given the benefit of this disclosure.

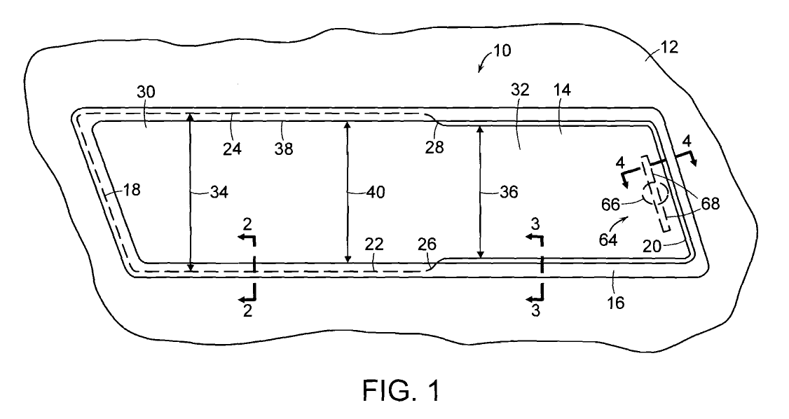

Referring now to the drawings, FIG. 1 shows a preferred embodiment of a window assembly 10 seated in an opening in a body 12 of a vehicle. Window assembly 10 has a pane 14 supported by a frame 16. Pane 14 may be made of either a generally transparent glass or plastic, such as a polycarbonate.

The term outwardly and inwardly refer generally to the directions of travel of a portion of pane 14 toward an open position or closed position, respectively. Thus, in the window assembly embodiment as shown in FIG. 1, outwardly is generally out of the page in the direction of the reader, while inwardly is into the page. The terms bottom, lower or the like refer generally to a position or location below or downward from a reference point, and the terms top or upper or the like refer generally to a position or location above or upward from a reference point. Thus, in the window assembly embodiment as shown in FIG. 1, bottom refers to the bottom of the page, while top refers to the top of the page.

The terms interior and exterior or inside and outside are used here to refer generally to the inside and outside of window assembly 10. Thus, the exterior side or surface of the window assembly embodiment shown in FIG. 1 is the side viewed in the drawing and the interior side or surface is the opposite side, i.e., the side facing away from the viewer. In automotive applications, for example, the interior or inside of the window assembly is the side facing into the passenger compartment (or designed, when installed, to face into the passenger compartment). Correspondingly, the exterior faces outwardly, e.g., to the weather.

Pane 14 has a first or left side edge 18 and a second or right side edge 20, opposite first side edge 18. Pane 14 has a third or bottom side edge 22 and a fourth or top side edge 24, opposite third side edge 22. In the illustrated embodiment, first side edge 18 and second side edge 20 are angled with respect to the substantially horizontal third and fourth side edges 22, 24. It is to be appreciated that, in certain embodiments, first and second side edges 18, 20 may extend substantially vertically. Although first side edge 18 is shown here to be substantially parallel to second side edge 20, it is to be appreciated that first and second side edges 18, 20 need not necessarily be substantially parallel. Similarly, third and fourth side edges 22, 24 need not necessarily be substantially parallel to one another as they are seen in this embodiment.

A first offset 26 is formed along third side edge 22 and a second offset 28 is formed along fourth side edge 24. First and second offsets 26, 28 act to define a first portion 30 and a second portion 32 of pane 14. First offset 26 comprises a portion of third side edge 22 that is angled upwardly from first portion 30 to second portion 32. Similarly, second offset 28 comprises a portion of fourth side edge 24 that is angled downwardly from first portion 30 to second portion 32.

First portion 30 has a first cross-dimension 34, measured from third side edge 22 to fourth side edge 24, which is seen here as a height of first portion 30 given the orientation of the illustrated embodiment. Similarly, second portion 32 has a second cross-dimension 36, measured from third side edge 22 to fourth side edge 24, which is seen here as a height of first portion 30 given the orientation of the illustrated embodiment. Frame 16 defines an opening 38 with a third cross-dimension 40, measured in the same direction as first and second cross-dimensions 34, 36, that is smaller than first cross-dimension 34, yet larger than second cross-dimension 36. Naturally, first cross dimension 34 is larger than second cross-dimension 36.

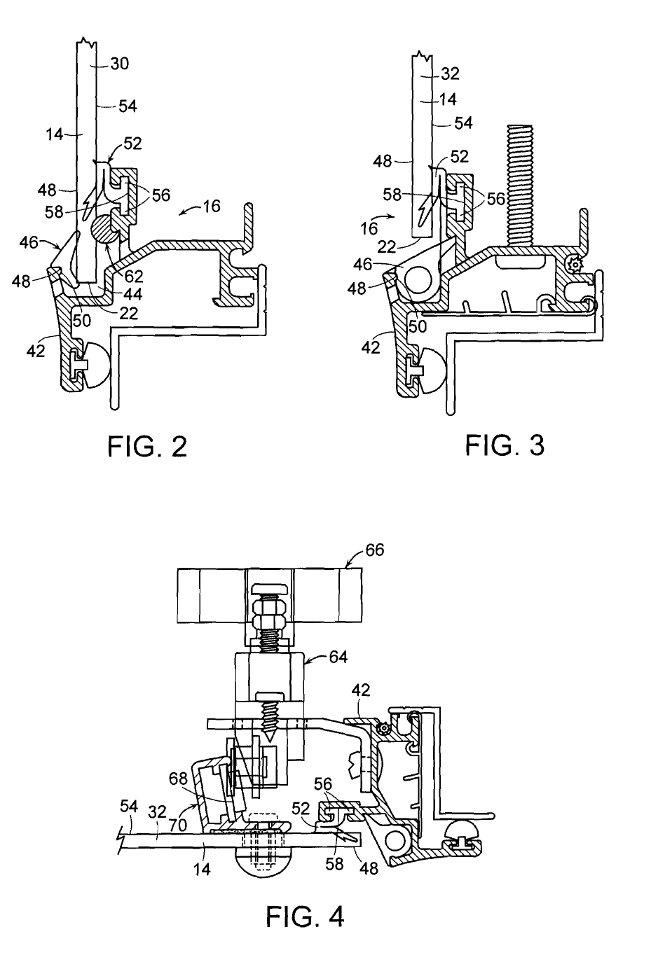

Thus, it can be seen that first portion 30, having a larger first cross-dimension 34 than third cross-dimension 40 of opening 40 is captured or fixed within frame 16. Consequently first side edge 18, and the portions of third side edge 22 and fourth side edge 24 that extend along first portion 30 of pane 14 are seated or received in frame 16. This is shown more clearly in FIG. 2, where it can be seen that the bottom or third side edge 22 of pane 14 is captured within frame 16. Frame 16 includes a frame member 42 that defines a substantially U-shaped channel 44 into which third side edge 22 projects. It is to be appreciated that channel 44 extends along frame 16 and that first side edge 18 and fourth side edge 24 also project into channel 44.

Frame member 42 may be formed of metal, e.g., aluminum, plastic, or any other suitable material. Frame member 42 may be extruded, molded, milled, or manufactured in any other suitable manner.

A glazing member 46 extends between frame member 42 and an exterior surface 48 of first portion 32 of pane 14. In certain embodiments, glazing member 46 is positioned between frame member 42 and exterior surface 48 of pane 14 in snap-fit fashion. In the illustrated embodiment, glazing member 46 is substantially V-shaped, with a recess 48 formed on the exterior of an apex of its V shape. A projection 50 formed on frame member 42 engages recess 48, thereby registering glazing member 46 with respect to frame member 42 and pane 14.

A seal member 52 extends between frame member 42 and an interior surface 54 of pane 14. In certain embodiments, seal member 52 includes a pair of flanges 56 that are received in a channel 58 formed in frame member 42, thereby securing seal member 52 to frame member 42.

A bead of sealant 62 may be positioned between frame member 42 and interior surface 54 of pane 14. It is to be appreciated that glazing member 46, seal member 52, and sealant 62 are formed of resilient and substantially compressible materials. Glazing member 46 may be formed of rubber, vinyl, or flexible PVC, for example. Seal member 52 may be formed of rubber, vinyl, or flexible PVC, for example. Sealant 62 may be formed of urethane, silicone, or any other flexible adhesive material. Other suitable materials for glazing member 46, seal member 52 and sealant 62 will become readily apparent to those skilled in the art, given the benefit of this disclosure.

Glazing member 46, seal member 52 and sealant 62 are shown in FIG. 2 in their natural, that is, non-compressed, condition for illustration purposes. It is to be appreciated that each of these elements would naturally be compressed when pane 14 is installed within frame 16, thereby providing retaining and sealing forces on pane 14.

Second portion 32, having a cross-dimension 36 that is smaller than third cross-dimension 40 of opening 38, is free to move outwardly with respect to frame 16 and first portion 30. As seen in FIG. 3, second portion 32 of pane 14 is not contained within frame 16 and, therefore, second portion 32 is free to move or flex outwardly, toward the left as illustrated here, away from frame 16. Seal member 52 is positioned between interior surface 54 of pane 14 and frame member 42. As noted above, seal member 52 is shown here in its natural, that is, non-compressed, condition for illustration purposes. It is to be appreciated that seal member 52 would naturally be compressed between interior surface 54 of pane 14 and frame member 42 when pane 14 is installed within frame 16, thereby providing retaining and sealing forces on pane 14.

It can be seen that first and second portions 30, 32 of pane 14 are substantially co-planar when pane 14 is in its closed position. However, when second portion 32 is flexed outwardly into the open position, the planes of first and second portions 30, 32 are at an angle greater than zero with respect to one another.

Thus, first portion 30 is fixed within frame 16 while second portion 32 is free to move outwardly with respect to frame 16 and first portion 30. Due to the fact that first portion 30 is fixed within, or restrained by, frame 16, second portion 32 flexes outwardly. Such a construction is advantageous in that it reduces the number of components required for window assembly 10, thereby simplifying manufacturing and reducing costs.

An operator 64 is used to move or flex second portion 32 outwardly with respect to frame 16 and first portion 30 of pane 14 to its open position, as well as move second portion 32 back to its closed position. In the illustrated embodiment, operator 64 is a twin arm operator having a handle or hand crank 66 that is secured to frame member 42. Upon rotation of hand crank 66 in a first direction, a pair of arms 68 move along a track 70, which is secured to second portion 32 of pane 14. As arms 68 move along track 70, twin arm operator 64 operates in known fashion to force second portion 32 from its closed position, as illustrated here, outwardly away from frame 16 to its open position. To return second portion 32 of pane 14 to its closed position, hand crank 66 is simply rotated in a second opposite direction.

It is to be appreciated that any type of operator may be used to move second portion 32 between its closed and open positions. For example, an over-center type of manual operator could be used in certain embodiments. In other embodiments, a powered operator could be used to open and close second portion 32.

In the embodiment illustrated in FIG. 1 and described herein, window assembly 10 is oriented in a substantially horizontal direction with its right side being movable between open and closed positions. In such an embodiment the front of the vehicle may be toward the left as seen in FIG. 1. However, it is to be appreciated that window assembly 10 can be oriented in any desired direction with respect to the vehicle, and that any orientations of window assembly 10 are considered to be within the scope of the present invention.

Thus, while there have been shown, described, and pointed out fundamental novel features of various embodiments, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is the intention, therefore, to be limited only as indicated by the scope of the claims appended hereto.

What is claimed is:

1. A motor vehicle window assembly comprising:
a frame;
a pane having a first portion fixed within the frame and a second portion movable relative to the first portion and the frame from a closed position to an open position;
a seal between the frame and the pane; and
an operator connected to the frame and the second portion, the operator moving the second portion between the closed and open positions.

2. The window assembly of claim 1, wherein the operator is a twin arm operator.

3. The window assembly of claim 2, wherein the operator comprises:
a track secured to an interior surface of the second portion;
a pair of arms movable along the track; and
a hand crank connected to the frame and the arms and operable to drive the arms along the track.

4. The window assembly of claim 1, further comprising a glazing member positioned between the first portion of the pane and the frame.

5. The window assembly of claim 1, further comprising a bead of sealant between the first portion of the pane and the frame.

6. The window assembly of claim 1, wherein the seal includes a pair of flanges received in a channel formed in the frame.

7. The window assembly of claim 1, wherein the frame is formed of extruded aluminum.

8. A motor vehicle window assembly comprising:
a frame;
a pane having a first side edge, a second side edge opposite the first side edge, a third side edge extending between the first and second side edges, and a fourth side edge extending between the first and second side edges and opposite the third side edge, the first side edge and a portion of each of the third and fourth side edges being fixed within the frame, the second side edge and a portion of each of the third and fourth side edges being movable outwardly from the frame;
a seal between the frame and the pane; and
an operator connected to the frame and the second portion, the operator moving the second portion between the closed and open positions.

9. The window assembly of claim 8, wherein the operator is a twin arm operator.

10. The window assembly of claim 9, wherein the operator comprises:
a track secured to an interior surface of the second portion;
a pair of arms movable along the track; and
a hand crank connected to the frame and the arms and operable to drive the arms along the track.

11. The window assembly of claim 8, further comprising a glazing member positioned between the first portion of the pane and the frame.

12. The window assembly of claim 8, further comprising a bead of sealant between the first portion of the pane and the frame.

13. The window assembly of claim 8, wherein the seal includes a pair of flanges received in a channel formed in the frame.

14. The window assembly of claim 8, wherein the frame is formed of extruded aluminum.

15. A motor vehicle window assembly comprising:
a frame;
a pane having a first side edge, a second side edge opposite the first side edge, a third side edge extending between the first and second side edges, and a fourth side edge extending between the first and second side edges and opposite the third side edge, the pane having a first cross-dimension between the third and fourth side edges proximate the first side edge and a second cross-dimension between the third and fourth side edges proximate the second side edge, the first cross-dimension being larger than the second cross-dimension, a first portion of the pane having the first cross-dimension being fixed within the frame, a second portion of the pane having the second cross-dimension being movable outwardly from the frame;
a seal between the frame and the pane; and
an operator connected to the frame and the second portion, the operator moving the second portion between the closed and open positions.

16. The window assembly of claim 15, further comprising:
a first offset on the third side edge extending between the first portion and the second portion; and
a second offset on the fourth side edge extending between the first portion and the second portion.

17. The window assembly of claim 15, wherein the operator is a twin arm operator.

18. The window assembly of claim 17, wherein the operator comprises:
a track secured to an interior surface of the second portion;
a pair of arms movable along the track; and
a hand crank connected to the frame and the arms and operable to drive the arms along the track.

19. The window assembly of claim 15, further comprising a glazing member positioned between the first portion of the pane and the frame.

20. The window assembly of claim 15, further comprising a bead of sealant between the first portion of the pane and the frame.

21. The window assembly of claim 15, wherein the seal includes a pair of flanges received in a channel formed in the frame.

22. The window assembly of claim 15, wherein the frame is formed of extruded aluminum.
